(19) United States
(12) Patent Application Publication
(10) Pub. No.: US 2026/0034951 A1
(43) Pub. Date: Feb. 5, 2026

(54) EVENT DETECTION MODULE CONTROL METHOD IN PARKING RECORDING MODE FOR REDUCING POWER CONSUMPTION, EVENT DETECTION MODULE CONTROL SYSTEM, AND COMPUTER-READABLE RECORDING MEDIUM

(71) Applicant: THINKWARE CORPORATION, Seongnam-si (KR)

(72) Inventors: Soon Woo PARK, Seongnam-si (KR); Kang Sik KIM, Seongnam-si (KR)

(21) Appl. No.: 18/947,426

(22) Filed: Nov. 14, 2024

(30) Foreign Application Priority Data
Nov. 15, 2023 (KR) 10-2023-0158613
Nov. 15, 2023 (KR) 10-2023-0158660
Nov. 14, 2024 (KR) 10-2024-0161977

(51) Int. Cl. B60R 16/033; G06T 7/50; G06V 10/12; G06V 20/40; G06V 20/52; G06V 20/58; H04N 23/65

(52) U.S. Cl. CPC B60R 16/033; G06T 7/50; G06V 10/12; G06V 20/44; G06V 20/52; G06V 20/586; H04N 23/651; G06T 2207/30232; G06T 2207/30264

(57) ABSTRACT

An event detection module control system in a parking recording mode for reducing power consumption includes a camera including an imaging unit capturing a video, an event detection unit detecting an event, a parking environment analysis unit analyzing a parking environment, and a camera connector interfacing with a main body; and the main body including an image processing unit receiving and processing the video captured by the imaging unit, a power supply unit supplying power for an operation of the event detection module control system, a controller controlling an operation of the power supply unit, and a main body connector interfacing with the camera, wherein, in the parking recording mode, the controller analyzes the video captured by the imaging unit through the parking environment analysis unit and controls power of the imaging unit and the event detection unit to be turned on or off according to a parking environment of the vehicle.

### CROSS-REFERENCE TO RELATED APPLICATIONS

This application claims the benefit of Korean Application Nos. 10-2024-0161977, filed Nov. 14, 2024; 10-2023-0158613, filed Nov. 15, 2023; and 10-2023-0158660, filed Nov. 15, 2023, the disclosure of each of which is incorporated by reference herein in its entirety.

### TECHNICAL FIELD

The present invention relates to a control technology of an event detection module for reducing power consumption in a parking recording mode by using a motion detection function.

### TECHNOLOGY BACKGROUND OF THE INVENTION

Recently, the use of dash cams equipped with motion detection modules has been increased in order to enhance parking surveillance and security of vehicles, and dash cams have been generally designed by utilizing motion detection technology to reduce power consumption of camera modules. In particular, by applying a radar-based or sensor-based motion detection module, when a vehicle is parked, only essential components are activated and the other components are deactivated to minimize power consumption. However, despite the optimization, there is a problem in that the motion detection module itself continuously consumes power. The power consumption reduces the battery life due to the nature of products that use the vehicle's battery or external battery and also reduces the parking surveillance time of the dash cam.

Meanwhile, as the use of parking surveillance systems with built-in motion detection functions (a general term for those capable of detecting movement of an object ahead, such as a radar, a motion recognition sensor, and UWB), for example, digital video recording systems (DVRS), has increased, efficient power management has emerged as an important issue. When the DVRS switches to a parking mode, the motion detection module is initialized and activated. In order to reduce power consumption, technology of deactivating or turning off all unnecessary functions except for a microcontroller unit (MCU) responsible for minimal operations, such as motion detection or event detection, has been developed.

However, the existing control system for reducing power consumption has the following limitations. Specifically, the event detection module has to continuously operate in environments in which motion detection is difficult or in spaces which people or vehicles cannot access, so it consumes power unnecessarily. For example, in remote locations or closed parking spaces in which there is little movement around the vehicle, the module continuously operates, resulting in power consumption.

In addition, with the recent development of vehicle security and parking surveillance technology, the importance of technology that accurately recognizes objects around a vehicle and responds appropriately thereto has increased. In particular, technology of dynamically adjusting the detection resolution of the motion detection module by utilizing object recognition and distance information between the vehicle and an object has come to prominence as a method for increasing power efficiency in parking surveillance systems, such as dash cams.

In general, dash cams are designed to detect and record movement around a vehicle even when the vehicle is parked. Such a system uses motion detection and cameras to detect the movement of people or vehicles approaching a parked vehicle. However, high-resolution detection consumes a relatively large amount of power and affects the battery life of the vehicle. In particular, there is no need to continuously detect with high resolution even when there are no objects around the vehicle or when objects are far from the vehicle, resulting in unnecessary power consumption. Therefore, in order to solve the above problems, it is necessary to develop a technology that adjusts the resolution of a motion detection module depending on whether an object around a vehicle is recognized and a distance between an object and the vehicle.

### CONTENTS OF THE INVENTION

### Problems to be Solved

An aspect of the present invention may provide an event detection module control method capable of extending a total operation time of a parking mode by significantly reducing power consumption due to an operation of the event detection module.

An aspect of the present invention may also provide a technology of turning off or adjusting an operation of a motion detection module when it is detected that a motion detection function is unnecessary or inefficient by determining a surrounding environment.

An aspect of the present invention may also provide an event detection module control method capable of reducing power consumption by adjusting the resolution of a motion detection module according to whether an object around a vehicle is recognized and a distance between the object and the vehicle.

An aspect of the present invention may also provide an event detection module control method capable of minimizing power consumption by lowering the resolution of a motion detection module when an object around a vehicle is not detected or when an object is a certain distance away and capable of providing more accurate detection by increasing the resolution of the motion detection module when an object approaches the vehicle.

### Means for Solving the Problem

According to an aspect of the present invention, an event detection module control system in a parking recording mode for reducing power consumption may include: a camera including an imaging unit capturing a video, an event detection unit detecting an event, a parking environment analysis unit analyzing a parking environment, and a camera connector interfacing with a main body; and the main body including an image processing unit receiving and processing the video captured by the imaging unit, a power supply unit supplying power for an operation of the event detection module control system, a controller controlling an operation of the power supply unit, and a main body connector interfacing with the camera, wherein, in the parking recording mode, the controller analyzes the video captured by the imaging unit through the parking environment analysis unit and controls power of the imaging unit and the event detection unit to be turned on or off according to a parking environment of the vehicle.

The camera may include a first camera capturing a front video of the vehicle, and a second camera capturing a rear video of the vehicle, and the first camera and the second camera may be independently controlled according to the parking environment of the vehicle.

The parking environment analysis unit may be controlled to analyze whether there is an object adjacent to a front or rear of the vehicle.

The parking environment analysis unit may be controlled to further analyze a distance between the vehicle and the object adjacent to the front or rear of the vehicle.

The main body may further include a detection period adjusting unit adjusting a detection period of the event detection unit, and the controller may control the detection period adjusting unit to adjust at least one of a signal frequency modulation time (chirp time), an idle time, and a number of signal frequencies (number of chirps) of the event detection unit according to the distance between the vehicle and the object adjacent to the front or rear of the vehicle.

The controller may control to set the signal frequency modulation time (chirp time) to be short, the idle time to be long, or the number of signal frequencies (number of chirps) to decrease as the distance between the vehicle and the object adjacent to the front or rear of the vehicle increases.

The controller may control to set the signal frequency modulation time (chirp time) to be long, the idle time to be short, or the number of signal frequencies to increase as the distance between the vehicle and the object adjacent to the front or rear of the vehicle decreases.

The main body may further include an output adjusting unit adjusting an output of the event detection unit, and the controller controls the output adjusting unit to increase or decrease a power intensity of the event detection unit according to the distance between the vehicle and the object adjacent to the front or rear of the vehicle.

The controller may control the output adjusting unit to decrease the power intensity of the event detection unit as the distance between the vehicle and the object adjacent to the front or rear of the vehicle decreases.

The controller may control the output adjusting unit to increase the power intensity of the event detection unit as the distance between the vehicle and the object adjacent to the front or rear of the vehicle increases.

The parking environment analysis unit may be controlled to further analyze whether the object adjacent to the front or rear of the vehicle is a fixed structure.

The controller may control power supply of the imaging unit and the event detection unit of the first camera to be turned off when there is a fixed structure adjacent to the front of the vehicle and control power supply of the imaging unit and the event detection unit of the second camera to be turned off when there is a fixed structure adjacent to the rear of the vehicle.

The controller may control the power supply of the imaging unit and the event detection unit of the first camera to be periodically turned on at preset time intervals when there is a fixed structure adjacent to the front of the vehicle and control the power supply of the imaging unit and the event detection unit of the second camera to be periodically turned on at preset time intervals when there is a fixed structure adjacent to the rear of the vehicle.

According to another aspect of the present invention, an event detection module control method in a parking recording mode for reducing power consumption may include: vehicle's starting to enter a parking mode; controlling power supply to an imaging unit of the vehicle to be turned off and power supply to an event detection unit of the vehicle to be turned on; analyzing a parking environment of the vehicle; determining whether it is necessary to change a setting of the event detection unit; and changing the setting of the event detection unit, wherein the analyzing of the parking environment is performed by analyzing whether there is an object adjacent to a front or rear of the vehicle and a distance between the vehicle and the adjacent object, and the changing of the setting of the event detection unit is performed by turning off the power supply of the event detection unit or adjusting a signal frequency and an power intensity of the event detection unit.

When the adjacent object is analyzed as a fixed structure in the analyzing of the parking environment, the changing of the setting of the event detection unit may be performed by turning off the power supply of the event detection unit or periodically turning on the power supply of the event detection unit at preset time intervals.

When the adjacent object is analyzed as approaching the vehicle in the analyzing of the parking environment, a power intensity of the event detection unit may be controlled to decrease in the changing of the setting of the event detection unit, and when the adjacent object is analyzed as moving away from the vehicle in the analyzing of the parking environment, the power intensity of the event detection unit may be controlled to increase in the changing of the setting of the event detection unit.

When the adjacent object is analyzed as moving away from the vehicle in the analyzing of the parking environment, a signal frequency modulation time (chirp time) of the event detection unit may be set to be short, an idle time may be set to be long, or a number of signal frequencies (number of chirps) may be controlled to decrease in the changing of the setting of the event detection unit, and when the adjacent object is analyzed as approaching the vehicle in the analyzing of the parking environment, the signal frequency modulation time (chirp time) of the event detection unit may be set to be long, the idle time may be set to be short, or the number of signal frequencies (number of chirps) may be controlled to increase in the changing of the setting of the event detection unit.

The process of adjusting a signal frequency and the process of adjusting the power intensity of the event detection unit performed in the changing of the setting of the event detection unit may be simultaneously independently performed.

The event detection module control method may be provided by a computer-readable recording medium on which a program for executing the event detection module control method is recorded.

The event detection module control method may be provided as a computer program including a program code stored in a computer-readable recording medium to execute the event detection module control method is included.

### Effects of the Invention

The event detection module control system and method in a parking recording mode according to exemplary embodiments of the present invention may inhibit unnecessary power consumption by analyzing a parking environment of a vehicle and controlling power supply of an imaging unit and an event detection unit, thereby extending the battery life of the vehicle and enabling stable parking surveillance for a long time.

In addition, the present invention may minimize power consumption by appropriately turning power of the imaging unit and the event detection unit on/off or adjusting an output and detection period according to a parking environment of the vehicle, thereby reducing battery consumption of the vehicle and maintaining a parking surveillance function for a longer period of time.

In addition, the present invention may automatically adjust an optimal detection setting by analyzing the presence an object adjacent to the front and rear of the vehicle, a distance to the object, and whether the object moves through a parking environment analysis unit. In particular, in unnecessary surveillance situations, such as fixed structures adjacent to the front and rear of the vehicle, power of the event detection unit may be turned off or turned on periodically to save power, and when an adjacent object approaches or moves away from the vehicle, the detection setting may be dynamically changed to enable efficient surveillance.

In addition, the present invention adjusts a signal frequency modulation time (chirp time), idle time, and the number of signal frequencies (number of chirps) of the event detection unit according to a distance between the vehicle and the object, thereby providing improved resolution and resolving power through high detection resolution when the object approaches and switching to low resolution when the object moves away to reduce power consumption of the event detection unit, and such an optimized operation may provide the effect of reducing power consumption while maintaining detection performance.

In addition, the present invention may efficiently maintain detection performance by adjusting a power intensity of the event detection unit according to the distance between the vehicle and the object, thereby reducing the power intensity when the object approaches and increasing the power intensity when the object moves away, and accordingly, unnecessary power consumption may be reduced and the power efficiency of the entire system may be improved.

### BRIEF DESCRIPTION OF DRAWINGS

FIG. 1 is a configuration diagram illustrating an event detection module control system according to exemplary embodiments of the present invention.

FIG. 2 is a block diagram specifically illustrating an event detection module control system according to another exemplary embodiment of the present invention.

FIG. 3 is a block diagram specifically illustrating an event detection module control system according to an exemplary embodiment of the present invention.

FIG. 4 is a diagram illustrating a control scenario of an event detection module according to exemplary embodiments of the present invention.

FIG. 5 is a diagram illustrating a signal frequency control mechanism of the event detection unit.

FIGS. 6 (a) and 6 (b) are diagrams illustrating a power intensity control mechanism of the event detection unit.

FIG. 7 is a flowchart specifically illustrating an event detection module control method according to an exemplary embodiment of the present invention.

FIG. 8 is a block diagram specifically illustrating an event detection module control system according to another exemplary embodiment of the present invention.

### DETAILED DESCRIPTION

Hereinafter, exemplary embodiments of the present invention are described with reference to the accompanying drawings. The following description is provided to aid in the comprehensive understanding of methods, devices, and/or systems disclosed in the specification. However, the following description is merely exemplary and not provided to limit the present invention.

In the following description of the present invention, a detailed description of known functions and configurations incorporated herein will be omitted when it would make the subject matter of the present invention unclear. The terms used in the present specification are defined in consideration of functions used in the present invention, and may be changed according to the intent or conventionally used methods of clients, operators, and users. Definitions of the terms should be understood on the basis of the entire description of the present specification. Terms used in the following description are merely provided to describe exemplary embodiments of the present invention and are not intended to limit the inventive concept. As used herein, the singular forms “a,” “an” and “the” are intended to include the plural forms as well, unless the context clearly indicates otherwise. It will be further understood that the terms “comprises” or “has” when used in this specification, specify the presence of stated features, integers, steps, operations, elements, or a portion or combination thereof, but do not preclude the presence or addition of one or more other features, integers, steps, operations, elements, or a portion or combination thereof.

In describing elements of the present disclosure, the terms “first,” “second,” “A,” “B,” “(a),” and “(b)” may be used. These terms are merely for differentiating one element from another element, and the essence, number, order or sequence of a corresponding component should not be limited by the terms.

The present invention relates to an event detection module control system for reducing power consumption in a parking recording mode of a vehicle.

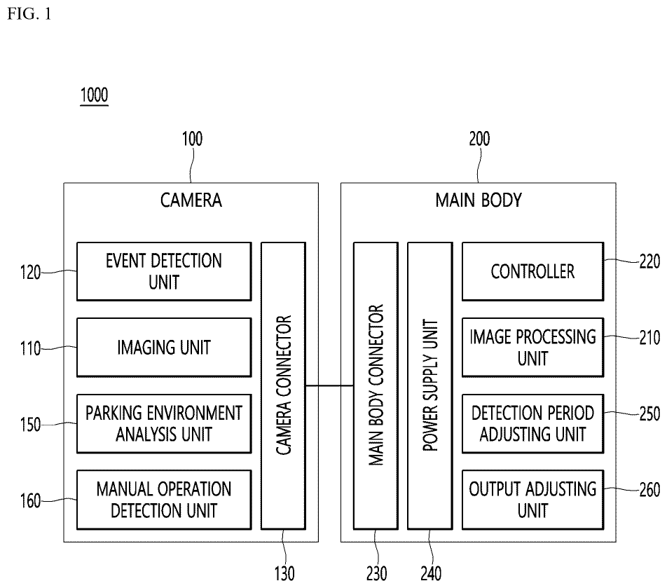

FIG. 1 is a configuration diagram illustrating a control system 1000 of an event detection module according to exemplary embodiments of the present invention.

Referring to FIG. 1, an event detection module control system 1000 is a system provided in a vehicle and captures videos in situations, such as driving, stopping, and parking of the vehicle and stores the captured videos and may include a camera 100 and a main body 200.

Here, the camera 100 and the main body 200 may be physically separated from each other and configured separately.

In the present invention, a vehicle is an example of a moving body, and the moving body of the present invention is not limited to vehicles. The moving body according to the present invention may include various objects that may move, such as a vehicle, a person, a bicycle, a ship, a train, etc. In the following, for convenience of description, a case in which the moving body is a vehicle will be described as an example.

In addition, in this specification, an act that triggers the operation of the event detection module control system 1000 is defined as an event. For example, the types of events may include events related to the presence or absence of an adjacent object and an adjacent distance, such as detection of an object adjacent to a front and rear of the vehicle, a change in an adjacent distance between the vehicle and the adjacent object, as well as an impact event, a motion event, a user gesture event, a user touch event, and an event receiving a control command from a remote location. Here, the event detection module control system 1000 may include all or some of a front imaging device that images the front of the vehicle, a rear imaging device that images the rear, a side imaging device that images the left and right sides, an imaging device that images the face of a vehicle driver, and an interior imaging device that images the interior of the vehicle.

A vehicle infrared camera, a vehicle black-box, a car dash cam, or a car video recorder are other expressions of the event detection module control system 1000, which may all refer to the same thing.

The camera 100 may include an imaging unit 110, an event detection unit 120 detecting an event, a parking environment analysis unit 150 analyzing a parking environment, and a camera connector 130 for interfacing with the main body 200, and the main body 200 may include an image processing unit 210 receiving and processing a video captured by the imaging unit 110, a power supply unit 240 supplying power for the operation of the event detection module control system 1000, a controller 220 controlling the operation of the power supply unit, and a main body connector 230 for interfacing with the camera 100.

The imaging unit 110 may capture a video of the surroundings of a moving body. Here, the video is captured in at least one situation among parking, stopping, and driving of the vehicle and may include at least one video of the front, rear, side, and interior of the vehicle. Here, the imaging unit 110 may include an infrared camera that may monitor the driver's face or pupil, and the controller 220 may determine the driver's condition, including whether the driver is drowsy, by monitoring the driver's face or pupil through the infrared camera.

The imaging unit 110 may include a lens unit, an image sensor, an image signal processor (ISP), a serializer, etc.

The event detection unit 120 is a sensor that detects an event and may include an impact event detection sensor that detects an impact applied to the vehicle and/or a motion event detection sensor that detects an object, such as a person, vehicle, or animal approaching the vehicle. However, without being limited thereto, the event detection unit 120 may be a concept that includes sensors that detect various events triggering the operation of the event detection module control system 1000. In an exemplary embodiment, the event detection unit 120 may include at least one of an impact event detection sensor and a motion event detection sensor. The event detection unit 120 may also be referred to as a motion detection module.

The camera connector 130 may perform an interface function between the camera 100 and the main body 200, such as receiving power from the main body 200 and performing data communication.

Meanwhile, the imaging unit 110 may further include a manual operation detection unit 160, and the manual operation detection unit 160 may be controlled by the controller 220 to determine whether the vehicle is manually operated by the driver.

The image processing unit 210 may receive and process a video captured by the imaging unit 110 and store the same in a memory (not shown). For example, the image processing unit 210 may analyze a video received from the camera 100 to perform an analysis to determine whether an advanced driving assistance system (ADAS) is required for the driver of the vehicle. Here, the ADAS may include detecting the departure of a vehicle located in front of the vehicle and informing the driver of whether a forward vehicle start alarm (FVSA) is required, detecting whether a signal has changed and informing the driver of whether a traffic light change alarm (TLCA) is required, detecting whether the vehicle has departed from a lane marking and informing the driver whether a lane departure warning system (LDWS) is required, detecting a risk of a collision with a vehicle in front of the vehicle and informing the driver of whether a forward collision warning system (FCWS) is required, etc.

The controller 220 may control the overall operation of the event detection module control system 1000. Specifically, the controller 220 may set a recording mode of the event detection module control system 1000 based on whether the vehicle has started, the result of measuring a vehicle battery voltage, whether the ADAS of the vehicle is required, an event detection result of the event detection unit 120, etc.

Here, the recording mode of the event detection module control system 1000 may include a driving recording mode and a parking recording mode. Here, the driving recording mode may be a recording mode when the vehicle is turned on, and the parking recording mode may be a recording mode when the vehicle is turned off.

In addition, the driving recording mode may include a constant recording mode, an event recording mode, and a manual recording mode.

The constant recording mode is a mode executed when the vehicle is turned on to start driving, and the constant recording mode may be maintained while the vehicle is driving. In the constant recording mode, the event detection module control system 1000 may perform recording at a predetermined time unit (for example, 1 to 5 minutes). In the present invention, the constant recording mode and the constant mode may be used to have the same meaning.

The event recording mode may refer to a mode activated when an impact event is detected by the event detection unit 120 while the vehicle is driving or when an ADAS event is detected. In the event recording mode, the event detection module control system 1000 may perform recording of time from a predetermined time before an event occurrence to a predetermined time after the event occurrence (for example, recording from 10 seconds before to 10 seconds after the event occurrence).

The manual recording mode may refer to an operating mode in which a user manually inputs recording while the vehicle is driving. In the manual recording mode, the event detection module control system 1000 may perform recording of time from a predetermined time before an event occurrence request from the user to a predetermined time after the event occurrence (for example, recording 10 seconds before or 10 seconds after the event occurrence).

The parking recording mode may refer to a mode that operates in a parking state when the vehicle is turned off or when a battery supply for driving the vehicle is cut off. In the parking recording mode, the event detection module control system 1000 may perform recording when an event is detected by the event detection unit 120 during parking. For example, the controller 220 may control the camera 100 to perform recording of a certain section from a predetermined time before the occurrence of an impact event and/or an event of detecting an approaching the vehicle to a predetermined time after the event occurrence (for example, recording from 10 seconds before to 10 seconds after the event occurrence).

In addition, the controller 220 may control power supply of the power supply unit 240 according to the recording mode of the event detection module control system 1000.

In particular, the controller 220 may control the power supply of the power supply unit 240 so that power consumption of the event detection module control system 1000 is minimized in the parking recording mode. For example, the controller 220 may control the power supply unit 240 to turn off the power supply to the imaging unit 110 in the parking recording mode and to turn on the power supply to the event detection unit 120.

The main body connector 230 may perform an interface function between the main body 200 and the camera 100, such as supplying power to the camera 100 and performing data communication.

The power supply unit 240 may receive power from the battery of the vehicle in which the event detection module control system 1000 is installed, and may supply power for the operation of the event detection module control system 1000 to the system 100 under the control of the controller 220.

Here, the battery supplying power to the power supply unit 240 may include at least one of a main battery for the vehicle in which the event detection module control system 1000 is installed and an auxiliary battery for the vehicle.

The main battery for the vehicle is a device that supplies power required for all electronic devices and starting in the vehicle, may generally start the vehicle, maintain an electrical system in the vehicle, and provide power required during driving.

The auxiliary battery for the vehicle may be a device that supplies power separately from the main battery for the vehicle so that the event detection module control system 1000 may operate continuously when the vehicle is turned off.

Meanwhile, the camera connector 130 and the main body connector 230 may be connected to each other through a cable connecting them. The camera connector 131 and the main body connector 230 may be connected to each other through a coaxial cable. However, without being limited thereto, a signal (power signal and data signal) line of the imaging unit 110 that images a video and a signal (power signal and data signal) line of the event detection unit 120 that detects an event in the parking recording mode may be configured separately from each other, and the controller 220 may control each line separately. In the present invention, an exemplary embodiment in which the camera connector 130 and the main body connector 230 are connected through a coaxial cable will be described in detail.

In exemplary embodiments, the controller 220 may analyze the video captured by the imaging unit 110 in the parking recording mode through the parking environment analysis unit 150 and control the power of the imaging unit 110 and the event detection unit 120 to be turned on or off according to the parking environment of the vehicle.

Specifically, the parking environment analysis unit 150 may be controlled by the controller 220 to analyze whether there is the object adjacent to the front or rear of the vehicle. Here, the parking environment analysis unit 150 may be configured to be constantly turned on in the parking recording mode, but the concept of the present invention is not necessarily limited thereto. That is, the parking environment analysis unit 150 may be configured to be controlled to be turned off when the analysis of the video or image captured by the imaging unit 110 in the parking recording mode is completed or may be configured to be controlled to be turned on temporarily when an event is detected by the event detection unit 120 and then turned off again when the analysis of the detected event is completed.

In an exemplary embodiment, the parking environment analysis unit 150 may be controlled to further analyze a distance between the vehicle and the object adjacent to the front or rear of the vehicle.

The main body 200 may further include a detection period adjusting unit 250 adjusting a detection period of the event detection unit 120, and the controller 220 may control the detection period adjusting unit 250 to adjust at least one of a signal frequency modulation time (chirp time), an idle time, and the number of signal frequencies (number of chirps) of the event detection unit 120 according to the distance between the vehicle and the object adjacent to the front or rear of the vehicle.

In an exemplary embodiment, the controller 220 may control to set the signal frequency modulation time (chirp time) of the event detection unit 120 to be shorter, set a signal frequency waiting time (idle time) of the event detection unit 120 to be longer, or decrease the number of signal frequencies (number of chirps) of the event detection unit 120 as the distance between the vehicle and the object adjacent to the front or rear of the vehicle increases.

Conversely, the controller 220 may control to set the signal frequency modulation time (chirp time) of the event detection unit 120 to be longer, set a signal frequency waiting time (idle time) of the event detection unit 120 to be shorter, or increase the number of signal frequencies (number of chirps) of the event detection unit 120 as the distance between the vehicle and the object adjacent to the front or rear of the vehicle decreases.

Meanwhile, the main body 200 may further include an output adjusting unit 260 for adjusting an output of the event detection unit 120, and the controller 220 may control the output adjusting unit 260 to increase or decrease a power intensity of the event detection unit 120 according to the distance between the vehicle and the object adjacent to the front or rear of the vehicle.

In an exemplary embodiment, the controller 200 may control the output adjusting unit 260 to decrease the power intensity of the event detection unit 120 as the distance between the vehicle and the object adjacent to the front or rear of the vehicle decreases.

Conversely, the controller 200 may control the output adjusting unit 260 to increase the power intensity of the event detection unit 120 as the distance between the vehicle and the object adjacent to the front or rear of the vehicle increases.

In another exemplary embodiment, the parking environment analysis unit 150 may be controlled to further analyze whether the object adjacent to the front or rear of the vehicle is a fixed structure.

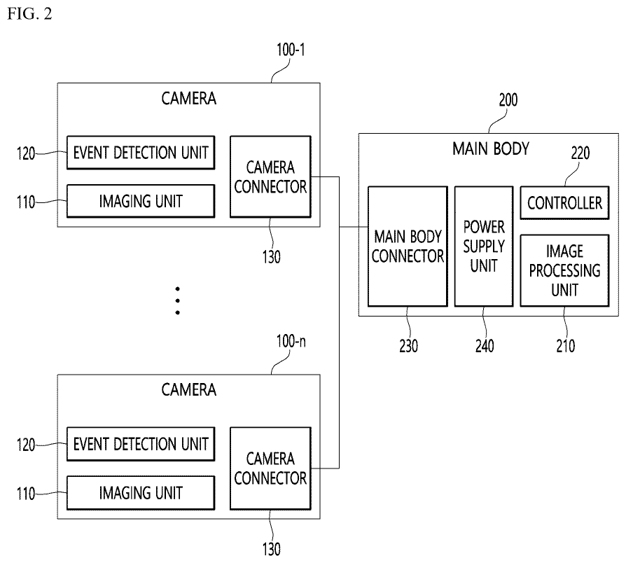

FIG. 2 is a block diagram specifically illustrating an event detection module control system according to another exemplary embodiment of the present invention.

Referring to FIG. 2, the main body 200 may be implemented with a plurality of cameras 100-1, 100-2, . . . , 100-n connected thereto. Here, each of the plurality of cameras 100-1, 100-2, . . . , 100-n may include all or some of a front camera, a rear camera imaging the rear, a side camera imaging the left and right sides, a camera imaging the face of a vehicle driver, and a camera imaging the interior of a vehicle. The videos imaged by each imaging unit 110 may be transmitted to the main body 200. The events detected by each event detection unit 120 may be transmitted to the main body 200. Here, the plurality of cameras 100-1, 100-2, . . . , 100-n and the main body 200 may communicate in a serial transmission manner. For convenience of description, a case in which the first camera is a front camera and the second camera is a rear camera will be described as an example.

In exemplary embodiments, the camera 100 may include a first camera 100-1 for capturing a front video of the vehicle and a second camera 100-2 for capturing a rear video of the vehicle, and the first camera 100-1 and the second camera 100-2 may be independently controlled according to the parking environment of the vehicle.

In an exemplary embodiment, the controller 220 may control power supply of an imaging unit and an event detection unit of the first camera 100-1 to be turned off when there is a fixed structure adjacent to the front of the vehicle and may control power supply of an imaging unit and an event detection unit of the second camera 100-2 to be turned off when there is a fixed structure adjacent to the rear of the vehicle.

In another exemplary embodiment, the controller 220 may control the power supply of the imaging unit and the event detection unit of the first camera 100-1 to be periodically turned on at preset time intervals when there is a fixed structure adjacent to the front of the vehicle and may control the power supply of the imaging unit and the event detection unit of the second camera 100-2 to be periodically turned on at preset time intervals when there is a fixed structure adjacent to the rear of the vehicle.

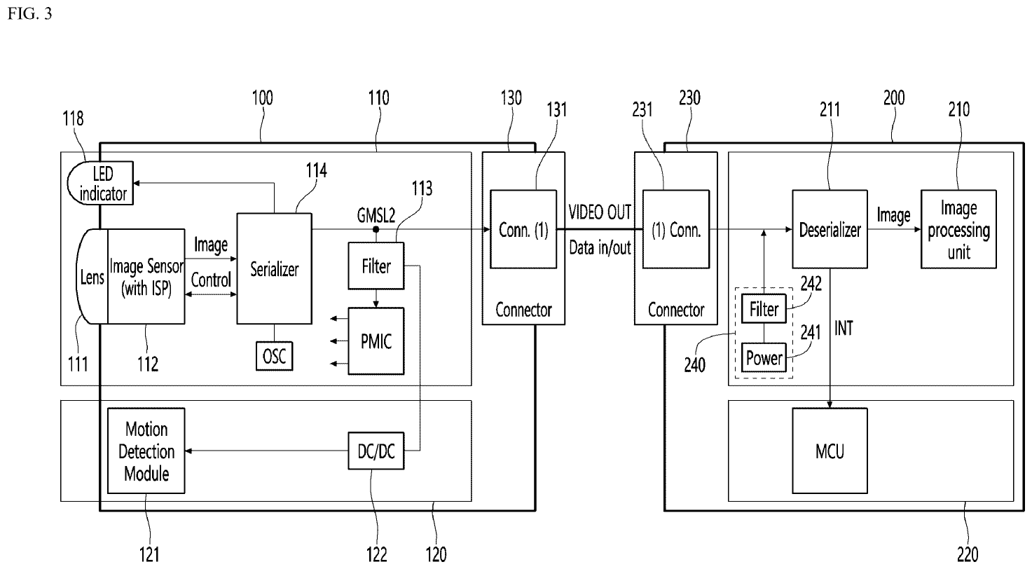

FIG. 3 is a block diagram specifically illustrating the event detection module control system according to an exemplary embodiment of the present invention.

Referring to FIG. 3, the imaging unit 110 may include a lens unit 111, an image sensor 112, a serializer 114, etc. The lens unit 111 may perform a function of collecting an optical signal, and the optical signal transmitted through the lens unit 111 reaches an imaging area of the image sensor 112 to form an optical image. Here, the image sensor 112 may use a charge coupled device (CCD), a complementary metal oxide semiconductor image sensor (CIS), or a high-speed image sensor that converts an optical signal into an electrical signal.

The image sensor 112 may include an image signal processor (ISP) that processes raw data collected from the image sensor. The image signal processor may perform functions, such as noise cancellation, white balance adjustment, gamma correction, color filter correction, and tone mapping.

The serializer 114 performs a function of converting a plurality of parallel data into one serial data. The serializer 114 may transmit the converted data to a deserializer 211 of the image processing unit 210 of the main body 200 through the first camera connector 131 of the camera connector 130 and a first main body connector 231 of the main body connector 230 and a cable connecting them.

Although not shown, the imaging unit 110 may further include a power over coax (POC) filter and may perform a function of separating the power supply and data signal not to be mixed when power and the data signal are transmitted simultaneously through a single coaxial cable. That is, when power is supplied to the imaging unit 110 through the coaxial cable and a video signal is transmitted at the same time, the power signal and the data signal may interfere, and the POC filter may inhibit this.

In addition, the imaging unit 110 may include a power management IC (PMIC), and the PMIC may be a power management integrated circuit that efficiently supplies and manages power to the imaging unit 110.

In addition, the imaging unit 110 may further include an indicator 118, and the indicator 118 may refer to an LED indicator or a notification device that visually informs the user of the status or operation of the event detection module control system 1000 described below. For example, the indicator 118 may provide information, such as whether the event detection module control system 1000 operates normally, whether recording is performed properly, or whether an error has occurred, thereby helping the user easily understand the status of the event detection module control system 1000. The indicator 118 may provide notification information to the user through various colors and blinking patterns, etc.

The event detection unit 120 may include an event sensing module (or a motion detection module) 121 and a DC-DC converter 122.

The event sensing module 121 may include an impact event sensing module and a motion event detection module. The impact event sensing module may be implemented as a G-sensor for detecting impact or acceleration, and the motion event detection module may be implemented as a radar sensor.

The event detection unit 120 may further include a voltage/current controller (not shown), the voltage/current controller may be configured to adjust the magnitude or intensity of a voltage or current of a power signal sequentially transmitted by way of the POC filter, the DC-DC converter 122, and the event sensing module 121, and the power signal having the voltage or current having the magnitude or intensity adjusted through the voltage/current controller may be merged into a data transmission signal of the serializer 114 and transmitted to the main body 200. In exemplary embodiments, the voltage/current controller may be controlled to adjust a normal voltage and/or normal current in the parking recording mode based on an interrupt signal generated from at least one of the impact event detection sensor and the motion event detection sensor.

Here, the main body 200 may further include a voltage/current detection unit (not shown) that detects a change in voltage and/or current of the camera 100, and the controller 220 may control the power supply to each of the imaging unit 110 and the image processing unit 210 to be turned on when a change in voltage is detected through the voltage/current detection unit.

The main body 200 may further include the deserializer 211 and the image processing unit 210.

The deserializer 211 may perform a function of converting serialized data back into original parallel data and restoring the data to its original form.

In exemplary embodiments, the voltage/current detection unit may be provided to detect a voltage before the signal line received from the first main body connector 231 is transmitted to the deserializer 211, and accordingly, the voltage in a state in which the signal line is not adjusted nor processed by another component may be accurately detected.

Alternatively, the voltage/current detection unit may be provided to detect the voltage before the signal line received from the first main body connector 231 is transmitted to the deserializer 211, so that the voltage in a state in which the signal line is not adjusted or processed by another component may be accurately detected.

The image processing unit 210 is a processor that processes and analyzes images and may additionally process basic video data processed by the image signal processing unit (ISP) through more complex operations. For example, the image processing unit 210 may perform AI-based image recognition, object tracking, etc.

For example, the image processing unit 210 may analyze a captured video of the imaging unit 110 to determine whether the aforementioned ADAS is required.

Meanwhile, according to the present invention, the signal (power signal and data signal) line of the imaging unit 110 that captures a video and the signal (power signal and data signal) line of the event detection unit 120 that detects an event in the parking recording mode may be merged into an integrated configuration, and the controller 220 may merge the signal line of the imaging unit 110 and the signal line of the event detection unit 120 into an integrated line and control the integrated line.

The main body 200 may further include a filter 242 that performs a function of separating the power and the data signal included in the integrated signal line so that they are not mixed before transmitting the integrated signal line received from the first main body connector 231 included in the main body connector 230 to the deserializer 211. That is, when receiving the power signal from the imaging unit 110 through the coaxial cable and simultaneously receiving a video signal, the power signal and the data signal may interfere, but the filter 242 may inhibit this.

Meanwhile, the power supply unit 240 of the main body 200 may include a power line supply unit 241, and the power line supply unit 241 may supply power for the operation of the imaging unit 110, the image processing unit 210, and the filter 242.

That is, the power supply ON/OFF of the power line supply unit 241 may be controlled by the controller 220.

Meanwhile, the camera connector 130 may include a first camera connector 131 formed in the camera 100, interfacing data communication between the imaging unit 110 and the image processing unit 210, and interfacing power supply between the imaging unit 110 and the power line supply unit 241.

In addition, the main body connector 230 may include a first main body connector 231 formed in the main body 200, interfacing data communication between the imaging unit 110 and the image processing unit 210, and interfacing power supply between the imaging unit 110 and the power line supply unit 241.

The “Conn.” of the first camera connector 131 and the first main body connector 231 may use a 1-pin FAKRA with a POC method, through which data signals and power signals may be transmitted and received between the first camera connector 131 and the first main body connector 231.

Meanwhile, the camera connector 130 and the main body connector 230 may be connected to each other through an integrated cable connecting them.

Meanwhile, the controller 220 may control the overall operation of the event detection module control system 1000. Specifically, the controller 220 may set the recording mode of the event detection module control system 1000 based on whether the vehicle is started, the result of measuring a vehicle battery voltage, whether the vehicle ADAS is required, and the detection result of the event detection unit 120. Here, the recording mode of the event detection module control system 1000 may include a driving recording mode and a parking recording mode.

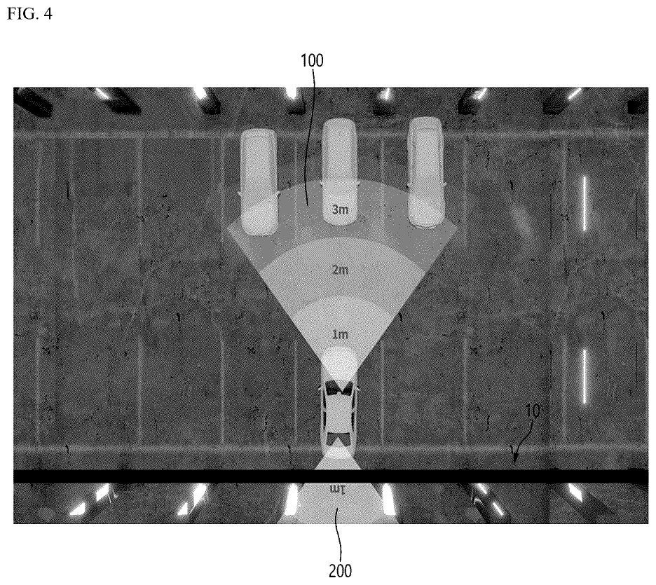

In addition, the controller 220 may control the power supply of the power supply unit 240 according to the recording mode of the event detection module control system 1000. Specifically, the controller 220 may control the power supply of the power supply unit 240 so that power consumption of the event detection module control system 1000 may be minimized in the parking recording mode. That is, the controller 220 may cause the event detection module control system 1000 to operate in a low power mode in the parking recording mode, thereby minimizing battery consumption of the vehicle. The operation of the controller 220 will be described below with reference to FIGS. 4 to 6.

FIGS. 4 to 6 are diagrams illustrating a control scenario of the event detection module according to exemplary embodiments of the present invention.

FIG. 4 illustrates a case in which there is a fixed structure at the rear of a vehicle and there are a plurality of other vehicles at the front of the vehicle.

Referring to FIG. 4, the first camera 100-1 of the vehicle may capture a front video, and the second camera 100-2 of the vehicle may capture a rear video.

Here, the parking environment analysis unit 150 of the camera 100 included in the vehicle may analyze the front image to determine that there are a plurality of other vehicles in front of the vehicle and may also analyze the rear image to determine that there is a wall 200, which is a fixed structure, at the rear of the vehicle.

In exemplary embodiments, the parking environment analysis unit 150 may collect data in real time through various sensors installed at the rear of the vehicle, and the sensors may include an ultrasonic sensor, a radar sensor, or a camera-based depth recognition sensor. The sensors may be controlled to detect distance and size information of the object at the rear of the vehicle.

In an exemplary embodiment, the parking environment analysis unit 150 may analyze the collected sensor data to determine whether there is an object at the rear of the vehicle, and to this end, may be controlled to calculate a distance between the detected object and the vehicle. The distance information may be used to determine how close the object is to the vehicle and may be classified as, for example, 1 m, 2 m, 3 m, etc. Here, if the detected object is determined to be fixed within a certain distance and not moving, additional analysis may be performed, and the object fixed in location may be determined to be an obstacle that does not move, such as a wall or structure, in the parking environment.

The parking environment analysis unit 150 may analyze not only the distance of the object, but also the characteristics of the object and whether it moves.

For example, the parking environment analysis unit 150 may further check whether the detected object remains stationary for a certain period of time, and through this, the parking environment analysis unit 150 may distinguish between a fixed structure, such as a wall, and a person or vehicle that moves.

In addition, since a fixed structure, such as a wall, generally has a large surface area and a specific shape, the parking environment analysis unit 150 may evaluate the size and shape of the object based on the collected data and determine that it is a fixed structure.

In addition, the parking environment analysis unit 150 may collect continuous distance data at predetermined time intervals to check whether the object remains stationary in the same location without moving. If there is no change in distance and the size and shape of the object match a wall, the object may be determined to be a fixed structure.

When the determination of the adjacent object is completed, the parking environment analysis unit 150 may transmit the analysis results to the controller 220, and the controller 220 may adjust the operations of the imaging unit 110 and the event detection unit 120 when a fixed structure is detected. In exemplary embodiments, when there is a wall 10 as a fixed structure at the rear, the imaging unit and the event detection unit of the second camera 100-2 may be turned off or set to be turned on periodically to reduce power consumption. In contrast, when a moving object, not a fixed structure, is detected, the controller 220 may set the imaging unit and the event detection unit of the second camera 100-2 to be turned on to monitor the object.

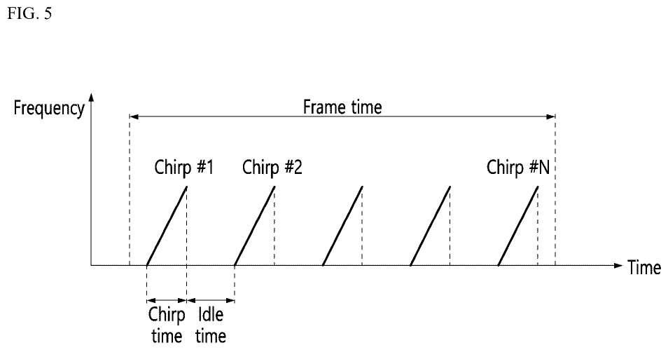

FIG. 5 is a diagram illustrating a signal frequency control mechanism of the event detection unit 120.

Referring to FIGS. 4 and 5 together, the event detection unit 120 may perform a frequency signal control mechanism for efficient management of detection signals and power consumption reduction when an object in front of the vehicle approaches or moves away. As shown in FIG. 5, the event detection unit 120 may include the signal frequency modulation time (chirp Time), the idle time, and the number of signal frequencies (number of chirps).

The modulation time (chirp time) refers to a time period during which the event detection unit 120 transmits a frequency modulation signal. If the modulation time is longer, the signal is transmitted for a longer period of time, which widens a detection range and allows more information to be collected, but power consumption increases. Meanwhile, if the modulation time is shorter, the transmitted signal is terminated sooner, which reduces power consumption, but the detection range may be narrowed. When an object approaches the vehicle, the modulation time may be set to be long for fast and accurate detection and the resolution of the detection performed by the event detection unit 120 may be increased to provide high-quality resolution and resolving power at important moments. On the contrary, when an object moves away, the modulation time may be set to be short to save energy and maintain the required resolution.

The idle time is the time for the event detection unit 120 to enter a standby state after a chirp signal of the frequency is transmitted. The idle time is used to reduce power consumption. If the idle time is long, the event detection unit 120 remains in an inactive state for a longer time to save energy, but a detection speed may be slowed down. If the idle time is short, the signal may be transmitted more frequently, improving detection responsiveness, but the power consumption of the event detection unit 120 may increase.

The number of signal frequencies (number of chirps) refers to the number of times the event detection unit 120 transmits a chirp signal within a frame time. Increasing the number of chirp signals, that is, the number of chirp signals, increases the detection accuracy and improves the detection quality of the event detection unit 120. As the more signals are transmitted, more detailed information is collected and the more improved resolution and resolving power may be provided, but the power consumption increases as much. Meanwhile, decreasing the number of signal frequencies, that is, the number of chirp signals, may reduce power consumption but may deteriorate the detection resolution.

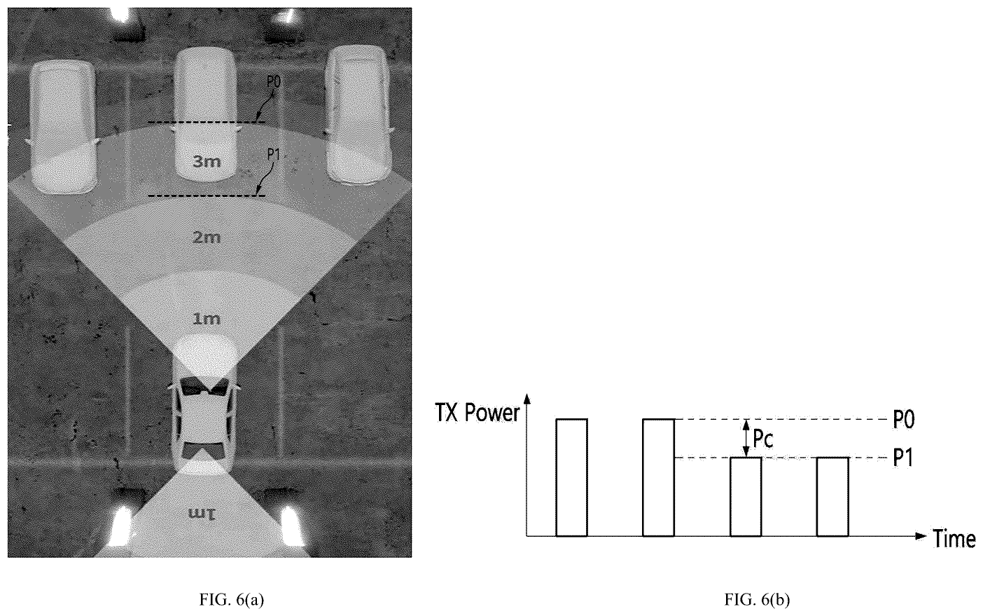

FIGS. 6 (a) and 6 (b) are diagrams illustrating a power intensity control mechanism of the event detection unit 120. FIG. 6 (a) is a diagram illustrating detection by dividing the front of the vehicle into units of meters (m), and FIG. 6 (b) is a diagram illustrating the power intensity control mechanism of the event detection unit 120.

Referring to FIG. 6 (a) and FIG. 6 (b), when there is an object around the vehicle, the event detection unit 120 may detect a distance to and location of the object and dynamically adjust a power intensity based on the detected information.

Specifically, when the distance between the vehicle and the object decreases, the power intensity of the event detection unit 120 may be lowered by considering both detection accuracy and energy efficiency, and when the object moves away, the power intensity of the event detection unit 120 may be increased to expand a detection range.

For example, when the distance between the vehicle and the object is far (e.g., 3 m or more), the event detection unit may be set to a high power intensity P0 to maintain the detection range as wide as possible, thereby effectively detecting an object at a distance. In contrast, as the distance between the vehicle and the object becomes closer (e.g., within 1 m to 2 m), the power intensity may be reduced to P1 to save energy. The power intensity setting as above is to inhibit unnecessary power consumption by using only the minimum power required to detect an object at a close distance.

The event detection unit 120 controls the power intensity based on the distance of the object in front of the vehicle. When the object is a preset distance from the vehicle, for example, 3 m or more, the power intensity is set to P0 to maximize the detection range. P0 is a high power intensity, which may provide a wide detection region around the vehicle and enable effective monitoring even when the object is far away.

If an object approaches the vehicle within the preset distance, for example, 3 m, the system lowers the power intensity to P1 to save energy. Here, P1 is a low power intensity, which may reduce the power consumption of the event detection unit by reducing the detection range. Here, although the detection range of the event detection unit 120 is reduced, it may be a suitable energy saving measure when the object is already close and higher resolution detection is unnecessary, and by lowering the power intensity in this manner, unnecessary power consumption during parking of the vehicle may be inhibited and the life of the vehicle battery may be extended.

Thereafter, when the object moves away again to the preset distance, for example, 3 m or more, the event detection unit 120 increases the power intensity to P0 to return to the basic detection range. Through this, a wide detection region may be reset, and the situation around the vehicle may be monitored accurately and promptly again.

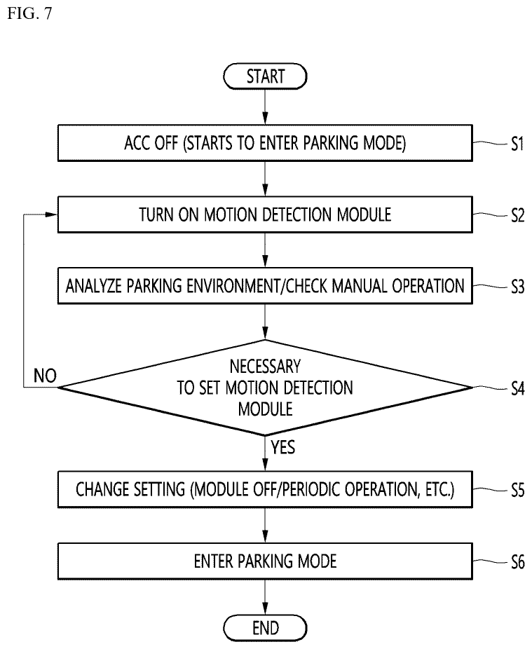

FIG. 7 is a flowchart specifically illustrating an event detection module control method according to an exemplary embodiment of the present invention.

Referring to FIG. 7, the event detection module control method according to exemplary embodiments of the present invention may include an operation (S1) in which a vehicle starts to enter a parking mode, an operation (S2) in which power supply to the imaging unit of the vehicle is turned off and power supply to the event detection unit of the vehicle is controlled to be turned on, an operation (S3) in which a parking environment of the vehicle is analyzed, an operation (S4) in which it is determined whether to change a setting of the event detection unit, and an operation (S5) in which a setting of the event detection unit is changed.

The parking environment analysis operation (S3) may be performed by analyzing whether there is the object adjacent to the front or rear of the vehicle and the distance between the vehicle and the adjacent object, and the operation (S5) of changing the setting of the event detection unit may be performed by turning off the power supply of the event detection unit 120 or adjusting a signal frequency and/or a power intensity of the event detection unit 120.

In the parking environment analysis operation (S3), when the adjacent object is analyzed as a fixed structure, the operation (S5) of changing the setting of the event detection unit may be performed by turning off the power supply of the event detection unit 120 or periodically turning on the power supply of the event detection unit 120 at preset time intervals.

When the adjacent object is analyzed as approaching the vehicle in the parking environment analysis operation (S3), the operation (S5) of changing the setting of the event detection unit may be controlled to decrease the power intensity of the event detection unit 120, and when the adjacent object is analyzed as moving away from the vehicle in the parking environment analysis operation (S3), the operation (S5) of changing the setting of the event detection unit may be controlled to increase the power intensity of the event detection unit 120.

When the adjacent object is analyzed to be moving away from the vehicle in the parking environment analysis operation (S3), the operation (S5) of changing the setting of the event detection unit may be controlled to set the signal frequency modulation time (chirp time) of the event detection unit to be short, set the idle time to be long, or reduce the number of signal frequencies (number of chirps), and when the adjacent object is analyzed to approaching the vehicle in the parking environment analysis operation (S3), the operation (S5) of changing the setting of the event detection unit may be controlled to set the signal frequency modulation time (chirp time) of the event detection unit to be long, set the idle time to be short, or increase the number of signal frequencies (number of chirps).

In an exemplary embodiment, the process of adjusting the power intensity of the event detection unit 120 and the process of adjusting the signal frequency performed in the operation (S5) of changing the setting of the event detection unit may be performed simultaneously and independently. That is, when an object adjacent to the front of the vehicle approaches within the preset distance, the power intensity of the event detection unit 120 may be controlled to decrease, and at the same time, the signal frequency modulation time (chirp time) of the event detection unit 120 may be set to be long, the idle time may be set to be short, or the number of signal frequencies (number of chirps) may be controlled to increase, and accordingly, the detection range of the event detection unit 120 may be reduced, while the event detection sensitivity may be set to increase. Meanwhile, when a signal frequency of the event detection unit 120 is adjusted, the imaging unit 110 and the image processing unit 210 may be woken up by the controller 220, and a signal frequency of the imaging unit 110 may also be adjusted together with the signal frequency adjustment of the event detection unit 120. That is, when the signal frequency modulation time (chirp time) of the event detection unit 120 is set to be long, the idle time of the event detection unit 120 is set to be short, or the signal frequency number (number of chirps) of the event detection unit 120 is controlled to increase, the signal frequency modulation time (chirp time) of the imaging unit 110 may also be set to be long, the idle time of the imaging unit 110 may also be set to be short, or the number of signal frequencies (number of chirps) of the imaging unit 110 may also be controlled to increase, and accordingly, an improved detection resolution, that is, a detection process having improved resolution and resolving power, may be performed by the event detection unit 120.

Meanwhile, the parking environment analysis operation (S3) may be performed by further analyzing whether the vehicle is manually operated, and when it is determined that the vehicle is driven by a manual operation (S4), the controller 220 may change the setting of the event detection unit 120 to a driving mode (S5).

In addition, in the operation (S4) of determining whether it is necessary to change the setting of the event detection unit, if it is determined that there is no object adjacent to the front or rear of the vehicle, the process may be controlled to be returned to the operation (S2) to turn on the power supply to the event detection unit of the vehicle.

Meanwhile, when the event that has occurred is terminated, that is, when the adjacent object no longer exists or moves farther than the detection range beyond the preset distance, the control may be performed to re-enter the parking mode (S6).

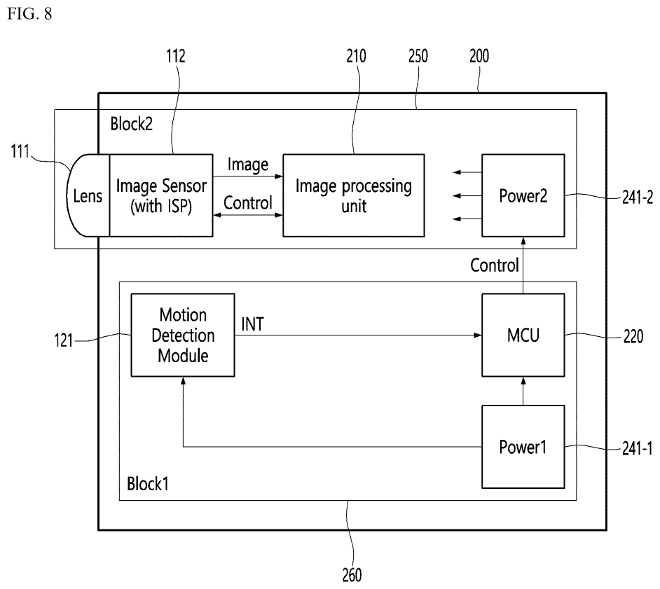

FIG. 8 is a block diagram specifically illustrating an event detection module control system according to another exemplary embodiment of the present invention.

The event detection module control system described based on FIG. 8 shows that some of the components of the camera 100 are merged into the main body 200 to form a single device.

Specifically, the event detection module control system according to another exemplary embodiment of the present invention may include only the main body 200.

The main body 200 may include the imaging unit 110 and the event detection unit 120, the imaging unit 110 may include the lens unit 111, the image sensor 112, and the image processing unit 210, and the event detection unit 120 may include the event sensing module 121 and the controller 220.

Meanwhile, the power supply unit 240 constituting the event detection module control system according to another exemplary embodiment of the present invention may include a first power supply unit 241-1 for supplying power to the event detection unit 120 and a second power supply unit 241-2 for supplying power to the imaging unit 110.

The first power supply unit 241-1 may be configured to constantly be driven and supply power even when the vehicle enters the parking mode and may be controlled to constantly be driven as long as a separate input is provided. Accordingly, the event detection unit 120 may be maintained in a state in which the power is constantly turned on in the parking mode by the first power supply unit 241-1. However, in special cases, for example, when there is a wall 10, which is a structure fixed to the rear region of the vehicle, the event detection unit 120 of the second camera 100-2 and the imaging unit 110 thereof may be maintained in a state in which the power is turned off.

The second power supply unit 241-2 may be configured to stop operation when the vehicle enters the parking mode so that power is not supplied, and thus the power supplied to the imaging unit 110 in the parking mode may be controlled to be cut off.

As described above, the event detection module control system and method in a parking recording mode according to exemplary embodiments of the present invention may inhibit unnecessary power consumption by analyzing a parking environment of a vehicle and controlling power supply of an imaging unit and an event detection unit, thereby extending the battery life of the vehicle and enabling stable parking surveillance for a long time.

In addition, the present invention may minimize power consumption by appropriately turning power of the imaging unit and the event detection unit on/off or adjusting an output and detection period according to a parking environment of the vehicle, thereby reducing battery consumption of the vehicle and maintaining a parking surveillance function for a longer period of time.

In addition, the present invention may automatically adjust an optimal detection setting by analyzing the presence an object adjacent to the front and rear of the vehicle, a distance to the object, and whether the object moves through a parking environment analysis unit. In particular, in unnecessary surveillance situations, such as fixed structures adjacent to the front and rear of the vehicle, power of the event detection unit may be turned off or turned on periodically to save power, and when an adjacent object approaches or moves away from the vehicle, the detection setting may be dynamically changed to enable efficient surveillance.

In addition, the present invention adjusts a signal frequency modulation time (chirp time), idle time, and the number of signal frequencies (number of chirps) of the event detection unit according to a distance between the vehicle and the object, thereby providing improved resolution and resolving power through high detection resolution when the object approaches and switching to low resolution when the object moves away to reduce power consumption of the event detection unit, and such an optimized operation may provide the effect of reducing power consumption while maintaining detection performance.

In addition, the present invention may efficiently maintain detection performance by adjusting a power intensity of the event detection unit according to the distance between the vehicle and the object, thereby reducing the power intensity when the object approaches and increasing the power intensity when the object moves away, and accordingly, unnecessary power consumption may be reduced and the power efficiency of the entire system may be improved.

However, the concept of the present invention is not necessarily limited thereto, and the device/method/system according to exemplary embodiments of the present invention may be applied to various products/technology fields in addition to the products/technology fields described above.

While various exemplary embodiments have been described in detail, a person skilled in the art will understand that the invention is not limited to the disclosed exemplary embodiments but may be variously modified within the scope of the present invention. Therefore, the scope of the present invention should not be limited to the aforementioned exemplary embodiments but should be determined by all changes or modifications derived from the scope of the appended claims and equivalents of the following claims.

1. An event detection module control system in a parking recording mode for reducing power consumption in a vehicle, the event detection module control system comprising:
a camera including an imaging unit configured to capture a video, an event detection unit configured to detect an event, a parking environment analysis unit configured to analyze a parking environment, and a camera connector configured to interface with a main body; and
the main body including an image processing unit configured to receive and process the video captured by the imaging unit, a power supply unit configured to supply power for an operation of the event detection module control system, a controller configured to control an operation of the power supply unit, and a main body connector configured to interface with the camera,
wherein, in the parking recording mode, the controller analyzes the video captured by the imaging unit through the parking environment analysis unit and controls power of the imaging unit and the event detection unit to be turned on or off according to a parking environment of the vehicle.

2. The event detection module control system of claim 1, wherein the camera includes a first camera configured to capture a front video of the vehicle, and a second camera configured to capture a rear video of the vehicle, and the first camera and the second camera are independently controlled according to the parking environment of the vehicle.

3. The event detection module control system of claim 2, wherein the parking environment analysis unit is controlled to analyze whether there is an object adjacent to a front or rear of the vehicle.

4. The event detection module control system of claim 3, wherein the parking environment analysis unit is controlled to further analyze a distance between the vehicle and the object adjacent to the front or rear of the vehicle.

5. The event detection module control system of claim 4, wherein
the main body further includes a detection period adjusting unit configured to adjust a detection period of the event detection unit, and
the controller controls the detection period adjusting unit to adjust at least one of a signal frequency modulation time (chirp time), an idle time, and a number of signal frequencies (number of chirps) of the event detection unit according to the distance between the vehicle and the object adjacent to the front or rear of the vehicle.

6. The event detection module control system of claim 5, wherein the controller controls to set the signal frequency modulation time (chirp time) to be short, the idle time to be long, or the number of signal frequencies (number of chirps) to decrease as the distance between the vehicle and the object adjacent to the front or rear of the vehicle increases.

7. The event detection module control system of claim 5, wherein the controller controls to set the signal frequency modulation time (chirp time) to be long, the idle time to be short, or the number of signal frequencies to increase as the distance between the vehicle and the object adjacent to the front or rear of the vehicle decreases.

8. The event detection module control system of claim 4, wherein the main body further includes an output adjusting unit configured to adjust an output of the event detection unit, and the controller controls the output adjusting unit to increase or decrease a power intensity of the event detection unit according to the distance between the vehicle and the object adjacent to the front or rear of the vehicle.

9. The event detection module control system of claim 8, wherein the controller controls the output adjusting unit to decrease the power intensity of the event detection unit as the distance between the vehicle and the object adjacent to the front or rear of the vehicle decreases.

10. The event detection module control system of claim 8, wherein the controller controls the output adjusting unit to increase the power intensity of the event detection unit as the distance between the vehicle and the object adjacent to the front or rear of the vehicle increases.

11. The event detection module control system of claim 3, wherein the parking environment analysis unit is controlled to further analyze whether the object adjacent to the front or rear of the vehicle is a fixed structure.

12. The event detection module control system of claim 3, wherein the controller controls power supply of the imaging unit and the event detection unit of the first camera to be turned off when there is a fixed structure adjacent to the front of the vehicle and controls power supply of the imaging unit and the event detection unit of the second camera to be turned off when there is a fixed structure adjacent to the rear of the vehicle.

13. The event detection module control system of claim 12, wherein the controller controls the power supply of the imaging unit and the event detection unit of the first camera to be periodically turned on at preset time intervals when there is a fixed structure adjacent to the front of the vehicle and controls the power supply of the imaging unit and the event detection unit of the second camera to be periodically turned on at preset time intervals when there is a fixed structure adjacent to the rear of the vehicle.

14. An event detection module control method in a parking recording mode for reducing power consumption in a vehicle when the vehicle is starting to enter a parking mode, the event detection module control method comprising:
detecting when the vehicle is starting to enter a parking mode;
controlling power supply to an imaging unit of the vehicle to be turned off and power supply to an event detection unit of the vehicle to be turned on;
analyzing a parking environment of the vehicle;
determining whether it is necessary to change a setting of the event detection unit; and
changing the setting of the event detection unit,
wherein the analyzing of the parking environment is performed by analyzing whether there is an object adjacent to a front or rear of the vehicle and a distance between the vehicle and the adjacent object, and
the changing of the setting of the event detection unit is performed by turning off the power supply of the event detection unit or adjusting a signal frequency and an power intensity of the event detection unit.

15. The event detection module control method of claim 14, wherein, when the adjacent object is analyzed as a fixed structure in the analyzing of the parking environment, the changing of the setting of the event detection unit is performed by turning off the power supply of the event detection unit or periodically turning on the power supply of the event detection unit at preset time intervals.

16. The event detection module control method of claim 15, wherein, when the adjacent object is analyzed as approaching the vehicle in the analyzing of the parking environment, a power intensity of the event detection unit is controlled to decrease in the changing of the setting of the event detection unit, and when the adjacent object is analyzed as moving away from the vehicle in the analyzing of the parking environment, the power intensity of the event detection unit is controlled to increase in the changing of the setting of the event detection unit.

17. The event detection module control method of claim 16, wherein,
when the adjacent object is analyzed as moving away from the vehicle in the analyzing of the parking environment,
a signal frequency modulation time (chirp time) of the event detection unit is set to be short, an idle time is set to be long, or a number of signal frequencies (number of chirps) is controlled to decrease in the changing of the setting of the event detection unit, and
when the adjacent object is analyzed as approaching the vehicle in the analyzing of the parking environment,
the signal frequency modulation time (chirp time) of the event detection unit is set to be long, the idle time is set to be short, or the number of signal frequencies (number of chirps) is controlled to increase in the changing of the setting of the event detection unit.

18. The event detection module control method of claim 17, wherein the process of adjusting a signal frequency and the process of adjusting the power intensity of the event detection unit performed in the changing of the setting of the event detection unit are simultaneously independently performed.

19. A computer-readable recording medium on which a program for executing the event detection module control method according to claim 14 is recorded.

20. (canceled)
